(19) United States
(12) Patent Application Publication
(10) Pub. No.: US 2018/0345715 A1
(43) Pub. Date: Dec. 6, 2018

(54) VARIABLE GLOSS HEAT TRANSFER LABELS

(71) Applicant: Illinois Tool Works Inc., Glenview, IL (US)

(72) Inventors: Michael B. Colella, Southington, CT (US); Carlos G. Altamirano, East Hartford, CT (US); Trinh Truong, Vernon, CT (US)

(21) Appl. No.: 15/977,625

(22) Filed: May 11, 2018

Related U.S. Application Data
(60) Provisional application No. 62/512,517, filed on May 30, 2017.

(51) Int. Cl. B44C 1/17; B44F 1/02; B41M 3/12

(52) U.S. Cl. CPC B44C 1/1716; B44C 1/172; G09F 2003/025; B41M 3/12; B44F 1/02

(57) ABSTRACT

A variable gloss heat transfer label includes a carrier, a matting layer on a portion of the carrier and a design layer having a first portion provided over the carrier and a second portion provided over the matting layer. The design layer is configured to separate from the matting layer and the carrier, and transfer and adhere the first and second portions of the design layer to a target object upon application of heat and pressure. The first portion of the design layer that is transferred to the target object from the carrier has a different gloss than the second portion of the design layer that is transferred to the target object from the matting layer. The label can be configured to include a carrier, a glossing layer on a portion of the carrier and a design layer having a first portion provided over the carrier and a second portion provided over the glossing layer.

### CROSS-REFERENCE TO RELATED APPLICATION DATA

This application claims the benefit of and priority to Provisional U.S. Patent Application Ser. No. 62/512,517, filed May 30, 2017.

### BACKGROUND

Heat transfer labels are well known and used in various industries. For example, heat transfer labels are used to transfer indicia onto commercial products, sports equipment, fabrics and other substrates. Typically, heat transfer labels include thermoplastic layers capable of being adhered to substrates upon application of heat and pressure.

UV curing heat transfer labels are also known. UV curing heat transfer labels can provide advantages over solvent-based or water-based thermoplastic ink systems since they do not emit volatile organic compounds and they exhibit improved abrasion resistance and chemical resistance. Such UV curing heat transfer labels are disclosed in Downs et al., U.S. Pat. No. 5,919,834, and Colella et al U.S. Pat. No. 9,266,373, which documents are commonly assigned with the present application and are incorporated in their entirety by reference. Colella et al. discloses a textured heat transfer label.

Heat transfer labels with a textured feel (e.g. raised and/or recessed areas) are known, such as those disclosed in Colella, U.S. Pat. No. 9,349,305, as are metallized heat transfer labels, such as those disclosed in Colella, et al., U.S. Pat. No. 7,910,203. Also known are embossed heat transfer labels, such as those disclosed in O'Leary, et al., U.S. Pat. No. 9,675,996. These labels are produced by printing an embossing layer that may, for example, include a pattern, on a carrier and printing a design layer over the embossing layer. The design layer is then transferred onto the item to decorated. The design layer as transferred to the item has the embossed pattern therein.

While all of these labels provide certain desired visual effects, they are all produced having a consistent gloss. That is, all of the portions of each label are consistently glossy, consistently matte, or at some consistent level of gloss between glossy and matte.

Accordingly, there is a need for a label, and method of making such a label, that provides a variable level of gloss on a single label, when transferred to an object.

### BRIEF SUMMARY

Various embodiments of a variable gloss heat transfer label and method for making the label provide a variable level of gloss on a single label, when transferred to an object. In some embodiments, the label includes a carrier, a matting layer on a portion of the carrier and a design layer having a first portion provided over the carrier and a second portion provided over the matting layer. The design layer is configured to separate from the matting layer and the carrier, and transfer and adhere the first and second portions of the design layer to a target object upon application of heat and pressure. The first portion of the design layer that is transferred to the target object from the carrier has a different gloss than the second portion of the design layer that is transferred to the target object from the matting layer.

In an embodiment, the first portion of the design layer that is transferred to the target object from the carrier has a higher gloss than the second portion of the design layer that is transferred to the target object from the matting layer.

Some embodiments include a release layer on the carrier, such that the matting layer is on a portion of the release layer, the first portion of the design layer is on the release layer and the second portion of the design layer is on the matting layer. The matting layer has a higher affinity for the release layer so that the matting layer remains on the release layer when the design layer is transferred to the target object.

In some embodiments the label includes an adhesive layer on the design layer, the adhesive layer adhering the design layer to the target object.

The matting layer can be formed from a first cross-linkable composition provided on the carrier or the release layer. The design layer can be formed from a second composition and configured to take up a matte finish from the matting layer. One suitable first cross-linkable composition is a silicone ink.

Inks used for the design layer can be formulated from components that will be recognized by those skilled in the art. The inks may be cross-linked to provide enhanced durability or the inks can be thermoplastic compositions. The design layer inks have a lower affinity for the matting layer (ink) and for the carrier (and its release layer if present) than for the target object; or the adhesive layer if one is used in the construction, in order to facilitate clean transfer to the target object when heat and pressure are applied to the back side of the carrier.

The carrier can include a release coating or layer. The composition of the release coating or layer can be formed from a variety of materials including waxes, high molecular weight acrylic coating resins, PVC, silicone coatings and the like. Suitable release coating or layer materials will be recognized by those skilled in the art.

In some embodiments, the adhesive layer is formed from a composition that includes a thermoplastic resin or mixture of thermoplastic resins that show an affinity for both the design layer (inks) and the target object. For example, if the target object is PVC then a solution of a vinyl chloride/vinyl acetate copolymer would be a suitable adhesive. In some embodiments, the adhesive layer is formed from an adhesive composition comprising a thermoplastic resin and hotmelt power. In some embodiments, the adhesive layer is formed from a hotmelt powder resin, and the hotmelt powder resin is thermoplastic polyurethanes, copolyesters, and/or copolyamides.

The matting layer is printed/applied so as to define a graphic area where a difference in gloss is desirable. The gloss of the matting layer can be controlled by the addition of standard matting agents. For example, it has been found that the addition of ACEMATT® TS 100, untreated thermal silica particles commercially available from Evonik, Industries of Essen, Germany, to a 2K silicone ink at zero, low, and high levels yield a matting ink with 60° gloss levels of 20.7, 12.8, and 5.2, respectively. Subsequently, the gloss of the design ink when transferred from these various silicone matting inks are 18.2, 11.0, and 4.4, respectively. That is, the matting layer is printed/applied so as to have a gloss differential of about 95+ relative to the design layer where there is no matting layer.

In an embodiment, the carrier has a composite foil layer, and at least a portion of the composite foil layer transfers with the design layer to the target object. In an embodiment another portion of the composite foil layer is overlain with the matting layer and does not transfer to the target object. The composite foil layer can include a metallizable layer and a metal layer. A metal layer transferring adhesive can be included on the composite, on the metal layer. The metal layer can be an aluminum layer.

In an embodiment, the heat transfer label includes a carrier having a matte finish, a glossing layer on a portion of the carrier and a design layer having a first portion provided over the carrier and a second portion provided over the glossing layer. In such an embodiment, the design layer is configured to separate from the glossing layer and the carrier and transfer and adhere the first and second portions of the design layer to a target object upon application of heat and pressure. The first portion of the design layer that is transferred to the target object from the carrier has a different gloss than the second portion of the design layer transferred to the target object from the glossing layer.

The first portion of the design layer that is transferred to the target object from the carrier has a lower gloss than the second portion of the design layer transferred to the target object from the glossing layer. The label can include a release layer on the carrier, such that the glossing layer is on a portion of the release layer, the first portion of the design layer is on the release layer and the second portion of the design layer is on the glossing layer, and in which the glossing layer has a higher affinity for the release layer so that the glossing layer remains on the release layer when the design layer is transferred to the target object.

A method of making a variable gloss heat transfer label includes the steps of printing a matting layer on a carrier and printing a design layer over at least a portion of the matting layer. When the variable gloss label is contacted to a target object and subject to heat and pressure, the design layer transfers to the target object such that a portion of the design layer overlying the matting layer has a matte finish and a portion of the design layer not overlying the matting layer has a gloss finish.

In a method the matting layer is printed on a carrier having a composite foil layer, and at least a portion of the composite foil layer transfers with the portion of the design layer to the target object. Another portion of the composite foil layer is overlain with the matting layer and does not transfer to the target object.

Other aspects, objectives and advantages will become more apparent from the following detailed description when taken in conjunction with the accompanying drawings.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a schematic cross sectional view of an embodiment of a variable gloss heat transfer label according to an embodiment;

FIG. 2 is a schematic cross sectional view of the variable gloss heat transfer label of FIG. 1 applied on a target object;

FIG. 3 is an overhead or plan view of an example of a variable gloss heat transfer label applied to a target object;

FIG. 4 is a schematic cross sectional view of another embodiment of a variable gloss heat transfer label;

FIG. 5 is a schematic cross sectional view of the variable gloss heat transfer label of FIG. 4 applied to a target object; and

FIG. 6 is an overhead or plan view of the variable gloss heat transfer label of FIGS. 4 and 5 applied to the target object

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

Referring now to the figures, FIG. 1 shows a schematic cross sectional view of an embodiment of a variable gloss heat transfer label 10. Layer thicknesses are exaggerated for easy understanding and are not proportional in this embodiment and other embodiments shown in other figures in this disclosure. The variable gloss heat transfer label 10 generally includes a carrier 12, such as a carrier web, a matting layer 14 and a design layer 16. The design layer 16 can be applied on the matting layer 14 and/or the carrier 12. The label 10 can include, optionally, one or both of a release layer or release coating 18 and an adhesive layer 20. In embodiments in which a release layer 18 is used, the release layer 18 typically, but not always, extends over the entirety of the carrier 12. Likewise, in embodiments in which an adhesive layer 20 is used, the adhesive layer 20 typically, but not always, extend over the entirety of the portion of the label to be transferred to a target object T.

The variable gloss heat transfer label 10 is configured such that the adhesive layer 20 and the design layer 16 transfer and adhere to the target object T, upon application of heat H and pressure P on an outer surface S of the carrier 12. When applied on the target object T, the matting layer 14 provides a matte appearance feature on the surface of the design layer 16 as applied to the target object T.

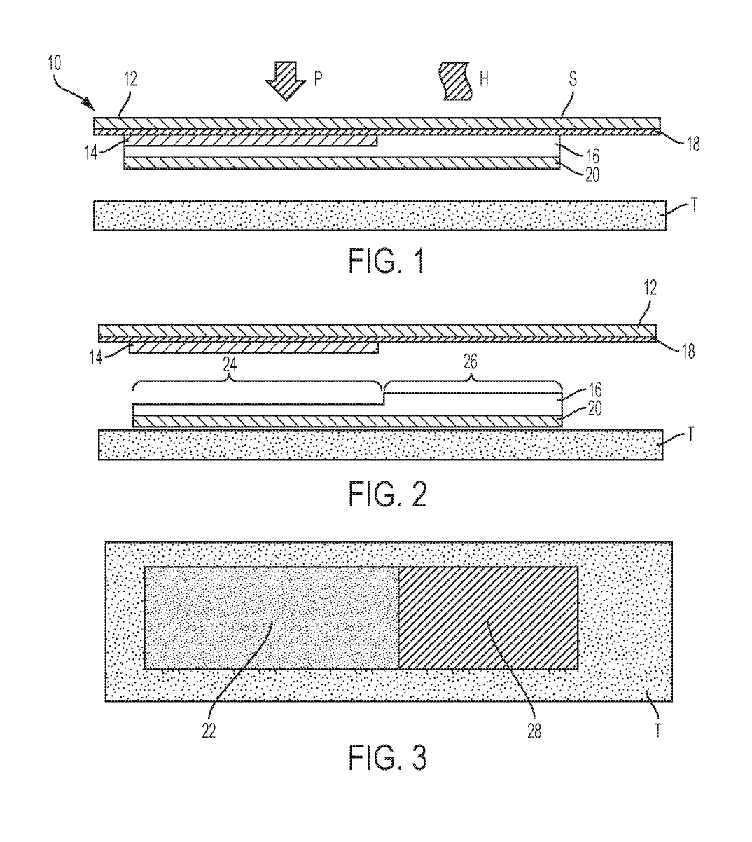

In an embodiment, the present variable gloss heat transfer label 10 uses a matting layer 14 on the carrier 12 (or the release layer 18 if used) onto which the design layer 16 is applied. A matte finish (as indicated at 22 in FIG. 3) is imparted to those areas (indicated at 24) of the design layer 16 that overlie the matting layer 14. The areas (indicated at 26) of the design layer 16 that do not overlie the matting layer 14 will have a finish similar to a conventional heat transfer label that is imparted by the carrier 12 or the release layer 18, typically a glossy finish (as indicated at 28 in FIG. 3). As seen in FIG. 2, when the label 10 is transferred to the target object T, the matting layer 14 remains on the carrier 12 or the release layer 18 and only the design layer 16 or the design layer 16 and adhesive 20, if used, is transferred to the object T. That is, the matting layer 14 has a greater affinity for the carrier 12 or release layer 20 than it does for the design layer 16.

In embodiments, the matting layer 14 is printed onto the carrier 12, and can include a pattern. As an example, a logo can be printed in or as a matting layer 14 that is applied to an area on the carrier 12 or the release layer 18. The design layer 16 can then be applied to the carrier 12 or release layer 18 on the area having the matting layer 14 and on a different area that does not have the matting layer. For example, a product name can be applied to the non-matting layer applied area. When the label 10 is transferred to the target object T, the logo will appear in a matte finish 22 and the product name will appear in a glossy finish 28. Thus, with one heat transfer label 10, both a glossy finish 28 and a matte finish 22 can be provided on a single transfer. As noted above, FIG. 3 illustrates the label 10 as applied to the target object T, and the area indicated at 22 represents the matte transferred and the area indicated at 28 represents the glossy transferred area.

The matting layer 14 is formed from a material that can retain the matte finish pattern under the heat H and pressure P applied during the label transferring process to the target object T. Suitable materials for the matting layer 14 include cross-linkable polymer inks. For example, the matting layer may be formed from a UV curable ink that is highly cross-linked when cured. The UV curable ink can be prepared by dissolving a thermoplastic resin in a monomer, an oligomer, or a monomer/oligomer mixture, and incorporating into a finished photoinitiated ink system. It should be understood that any monomer, oligomer, or monomer/oligomer mixture which can dissolve the thermoplastic resin component and remain compatible with the other components of the labels are acceptable. Suitable monomers for dissolving the thermoplastic resin component include esters of acrylic acid and methacrylic acid such as lauryl acrylate, isobornyl acrylate, 2-phenoxyethyl acrylate, glycidyl methacrylate, tetraethoxylated nonylphenol acrylate, and propoxylated neopentyl glycol diacrylate.

Thermoplastic resins suitable for the UV curable ink include epoxies, polyurethanes, polymethacrylates, polyethylene vinyl acetates, polyvinyl chlorides, vinyl chloride/vinyl acetate copolymers, functionalized vinyl chloride/vinyl acetate copolymers, chlorinated halogenated polyolefins such as chlorinated and fluorinated polyolefins, and polystyrene.

Suitable photocurable monomer initiators include benzophenone, alpha ketone, thiophenyl morpholinopropanone (Irgacure® 907), morpholinophenylaminohexanone (Irgacure® 369), cyclohexylphenyl ketone (Irgacure® 184), hydroxyphenylpropanone (Darocur® 1173), and isopropylthioxanthone (Darocur® ITX), alkylated benzophenone (Esacure® TZT), diphenyl (2,4,6-trimethylbenzoyl) phosphine oxide (Genocure® TPO), and poly 4-(2-hydroxy-2-methylpropionyl) alpha-methyl styrene (Escacure® KIP-100F). Irgacure® 907, 369, 184, Darocur® 1173, and Darocur® ITX are products available from BASF. Genocure® TPO is a product of RAHN. Generally, suitable initiators are those which produce free radicals upon exposure to UV radiation.

UV curable ink formulations similar to those disclosed in the aforementioned Downs et al., U.S. Pat. No. 5,919,834, which is incorporated herein in its entirety by reference, can be used to print the matting layer 14. Preferably, the matting layer 14 is formed using a highly cross-linked UV ink composition, which is formulated to bond to the carrier 12 and the release layer 18, if used. The composition includes more initiator or cross-linking agent than the formulations disclosed in Downs et al.

The UV ink formulations in Downs et al. are formulated to be heat transferable inks, while the UV ink formulation for the matting layer 14 need not be a heat transferable ink since the matting layer 14 is not configured to transfer to the target object T. Rather, the matting layer 14 is configured to remain bonded to the carrier 12, or release layer 18 if used, and retain the structure to form or define the matte finish 22.

Curing of the UV curable ink can be effected by exposing the ink to a suitable UV source, such as a Fusion Systems light source, using either a doped mercury type “D” or “V” lamp. The “D” outputs in the wavelength range of 340-390 nm. The “V” lamp outputs in the 400-430 nm range. The choice of pigment and initiator dictate which range (i.e. lamp) to use, and the selection process would be readily understood by the artisan skilled in printing with traditional UV curing inks. The UV curable ink is exposed under a suitable UV light source, which cures or cross links the UV curable ink into the matting layer formed of a highly cross-linked UV ink.

Other suitable materials for the matting layer 14 include solvent based inks and water based inks comprising cross-linkable polymers and a cross linking agent. For example, a suitable solvent based ink may be formulated with a hydroxyl functional resin and a polyisocyanate cross linking agent.

The matting layer 14 may be printed on the carrier 12 which can be formed from various materials, such as a paper or plastic film. One preferred carrier material is polyester film, which provides a suitable surface for printing the matting layer and favorable mechanical properties. For example, polyester does not soften and become tacky at the range of temperatures typically encountered during the label transfer process to the target object.

In one embodiment, the carrier 12 is formed from a 92 gauge (92 ga) clear, untreated packaging grade polyester film as is well known in the art. As can be readily appreciated, one benefit of using a clear material for carrier 12 is that, if desired, one can inspect the quality of the subsequent printed layers of the label 10 by looking at the layers through the carrier 12.

The material for the carrier is selected such that surface energy of the carrier 12 is sufficiently high for printing the matting layer 14 and the release layer 18, if used, and allow the matting layer 14 and the release layer 18 to remain bonded to the carrier 12 after the design layer 16 and the adhesive layer 20, if used, are transferred to the target object T upon application of heat H and pressure P.

The release layer 18, if used, is printed on the carrier 12. As shown in FIG. 1, the release layer 18 can be printed on a larger area than the matting layer 14 and the design layer 16. The release layer 18 is provided between the matting and design layers 14, 16 and the carrier 12. The matting layer 14, however, has a higher affinity for the carrier 12 or release layer 18 if used. The release layer 18, if used, is provided to facilitate a clean separation of the design layer 16 and the adhesive layer 20 if used, from the rest of the label structures, including the matting layer 14, upon application of heat H and pressure P. When a release layer 18 is used, it prevents the design layer 16 from bonding to the carrier 12 upon application of heat H and pressure P, and thus permits transfer of the design layer 16 to the target object T.

In one embodiment, the release layer 18 may be formed from a wax comprising thermoplastic polyamide resin having a softening point below the label 10 application temperature. In such an embodiment, the release layer 18 softens at application and becomes an anti-blocking layer, which allows the design layer 16 and the adhesive layer 20, if used, to release and transfer to the target object T.

The design layer 16 is printed over the release layer 18 if used, and the matting layer 14 on the carrier 12. The design layer 16 is formed using a material that can take up the matte pattern from the matting layer 14 and retain the matte finish 22 during the heat transfer process to the target object T. Further, the design layer 16 is configured to separate from the carrier 12 and/or the release layer 18 and matting layer 14, and cleanly transfer to the target object T and retain the matte finish pattern 22 when attached to the target object T. The design layer 16 inks have a lower affinity for the matting layer 14 (ink) and for the carrier 12 (and its release layer 18 if present) than for the target object T; or the adhesive layer 20 if one is used in the construction, in order to facilitate clean transfer to the target object T when heat and pressure are applied to the back side of the carrier 12.

Suitable materials for the design layer 16 include thermoplastic inks, and cross-linkable inks. For improved durability, the design layer 16 may be formed from an ink composition including a thermoplastic resin and a cross-linking agent. The suitable ink compositions may include UV curable inks and cross-linkable solvent based or water based inks. Further, suitable ink compositions may be formulated such that when the variable gloss label 10 is attached to the target object T, the ink compositions can provide durability necessary for testing and use while retaining the matte finish 22.

Suitable thermoplastic resins for the ink formulation for the design layer 16 include, but are not limited to, thermoplastic polyurethanes, vinyl chloride/vinyl acetate copolymers, polymethacrylates, epoxies, and copolyesters. The ink formulation may be formulated with polyols and isocyanates to provide cross-linking necessary for improved durability, such as laundry durability for applications where the target object is, for example, an apparel article. Further, the ink formulation may be pigmented with color, metallic, fluorescent, pearlescent, and/or iridescent specialty pigments. The ink may be clear or pigmented, which gives rise to different effects.

The matting layer 14 and the design layer 16 are cross linked prior to the heat transfer process. The cross linking of the matting layer 14 and the design layer 16 inks may be performed simultaneously or at different times. For example, in one embodiment, the matting layer 14 may be formed using a UV curable ink formulation, while the design layer 16 is formed from a solvent based ink formulation containing a hydroxyl resin and a polyisocyanate cross linking agent. In such an embodiment, the UV curable matting layer 14 may be cross linked during the printing process, while the cross linking of the design layer 16 is carried out after completion of the printing process. In such an embodiment, the design layer 16 is typically cured under an ambient condition for 7 days after printing. The ambient curing of the design layer 16 formed from a solvent based or water based cross-linkable ink formulation may be accelerated with application of heat. For example, the solvent based ink formulation containing a hydroxyl resin and a polyisocyanate cross linking agent, which typically cures for 7 days at room temperature, may be cured in 12 hours at 165° F.

Suitable ink formulations for the matting layer 14 include, but are not limited to, a 2K (two-component) silicone ink. For example, the matting layer 14 may be formed by a single print pass using a silicone ink, such as Alpatec® 30340, which is available from CHT R. Beitlich GMBH, or ImageStar® silicone textile ink, commercially available from Nazdar SourceOne of Shawnee, Kans. In an embodiment, the matting layer 14 is screen printed using a 2K silicone ink on the carrier 12 formed from a siliconized 92 gauge polyester film. The 2K silicone ink is 100% solid, thus, can provide a texture to provide a matte finish 22 while providing a surface over which the design layer 16 may be printed without bonding to the matting layer 14 to allow the design layer 16 to separate and transfer to a target object T during heat transfer application, leaving behind the design layer 16 with a matte finish 22 on those portions 24 of the design layer 16 overlying the matting layer 14. The matting finish (e.g., the gloss) can be controlled by the type and amount of matting agent added to the UV ink. For example, it has been found that the addition of ACEMATT® TS 100, untreated thermal silica particles commercially available from Evonik, Industries of Essen, Germany, to a 2K silicone ink at zero, low and high levels yield a matting ink with 60° gloss levels of 20.7, 12.8, and 5.2 respectively. Subsequently, the gloss of the design ink when transferred from these various silicone matting inks are 18.2, 11.0, and 4.4, respectively. That is, the matting layer is printed/applied so as to have a gloss differential of about 95+ relative to the design layer 16 where there is no matting layer 14 (e.g., area at 24 relative to area at 26 in FIG. 2). Gloss measurements were taken using a “micro-TRI-gloss meter” Model 4446 from BYK-Gardner USA of Columbia Md. Measurements were made with a 60° reflectance setting and in accordance with ASTM D523-14, “Standard Test Method for Specular Gloss” (Jan. 1, 2014), and ISO 2813:2014 “Paints and varnishes—Determination of gloss values at 20 degrees, 60 degrees, and 80 degrees” (Oct. 2014).

In some embodiments, the design layer 16 may be formed by multiple ink passes. In such embodiments, multiple passes of different color inks and designs may be printed to produce a multicolored graphic. Further, the design layer 16 may be printed in multiple passes. Further, the first print path of the design layer 16 formed by multiple print passes may be a clear protective layer.

Finally, the adhesive layer 20, if used, is applied over the design layer 16. The adhesive layer 20 may be formed from a thermoplastic composition that melts or softens upon application of heat H and pressure P, and adheres to the target object T to attach the variable gloss label 10 at the design layer 16 to the target object T. For example, suitable thermoplastic compositions may be formulated with thermoplastic resins and hotmelt powders. Suitable hotmelt powder resins include, but are not limited to, thermoplastic polyurethanes, copolyesters, and copolyamides. In such a thermoplastic composition, the hotmelt powder may be dispersed in thermoplastic resin binder and may have a particle size distribution suitable for the screen mesh being used for printing.

To apply the variable gloss heat transfer label 10, the label 10 is placed on the target object T, such that the design layer 16, or the adhesive layer 20 if used, faces the target object T. After adjusting the label 10 to a desired position on the target object T, sufficient heat H and pressure P are applied to the outer surface S of the carrier 12 using conventional heat transfer equipment. When heat H and pressure P are applied to the carrier 12, the design layer 16, or the adhesive layer 20, if used, melts or softens, and adheres to the target object T. Subsequently, a user may peel off the carrier 12, matting layer 14, and release coating 18, if used, by grabbing and pulling away the carrier 12 from the target object T. After the carrier 12 is removed along with the matting layer 14 and release coating 18, if used, the design layer 16 and the adhesive layer 20, if used, remain adhered to the target object T. The exposed design layer 16 reveals an area having a matte finish 22 that has been transferred to the design layer 16 from the matting layer 14 and an area having a glossy finish 28 on those areas not overlying the matting layer 14, on the target object T, as shown in FIGS. 2 and 3.

It is to be understood that the particular compositions of the carrier 12, matting layer 14, release layer 18, if used, design layer 16, and adhesive layer 20, if used, may vary from the specific compositions disclosed herein depending upon the composition of a target object T to which the label 10 is to be applied and the desired matte finish.

In another, related embodiment, the label 10 can be fabricated in the inverse of that shown in FIGS. 1 and 2. That is, the rather than the carrier 12 (or release layer 18) providing a smooth or glossy finish, the carrier 12 (or release layer 18) can be constructed so as to provide a matte finish and a glossing layer can be provided on the carrier 12 (or release layer 18) to effect a similar but opposite design than that of FIGS. 1-3. In such a construction, the glossing layer fills in the texture of the carrier 12 to yield a smooth, glossy surface on which to print.

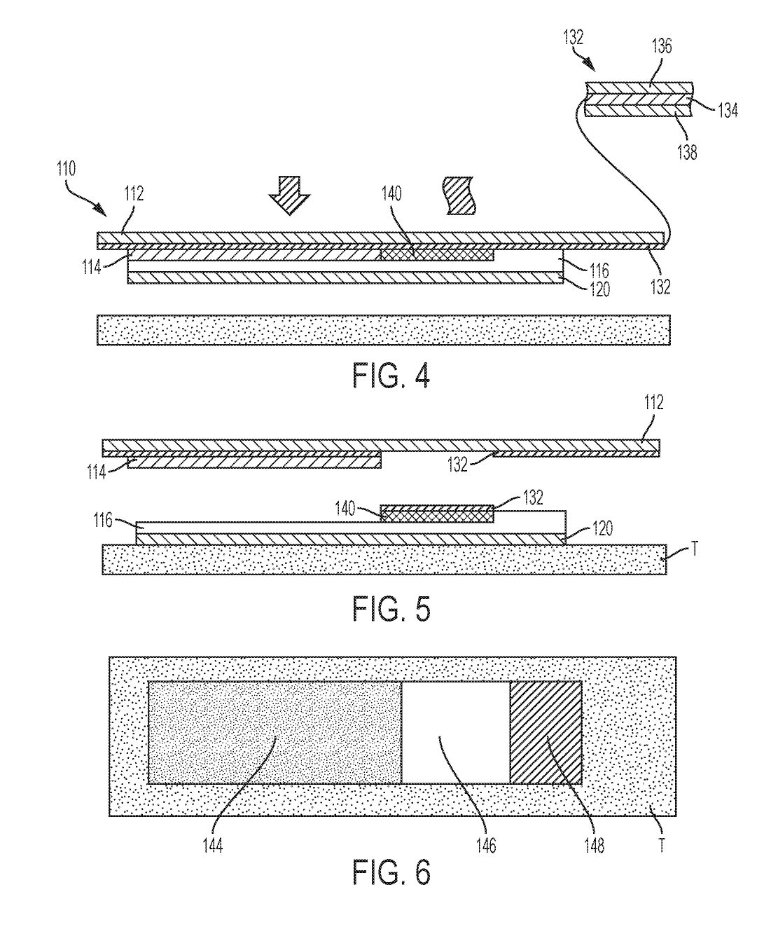

Referring to FIGS. 4-6, in an embodiment of the label 110, the carrier 112 is a foil with a composite layer 132 such as that described in Colella, et al., U.S. Pat. No. 7,910,203. One example of such a composite layer 132 includes a metallizable layer 134 applied to a protective layer 136, a metal layer 138, for example, an aluminum layer, applied to the metallizable layer 134. A metal transferring adhesive layer 140 is applied on the composite 132, over the metal layer 138. The metal layer 138 in the composite 132 is the last layer and serves as the printing surface. The matting layer 114 is formulated to have a stronger affinity for the composite layer 132 than for the design layer 116 or the design layer 116 ink. The foil adhesive 140 is printed in an area on the graphic where it is desired to have a metallic finish, as indicated at 146 in FIG. 6.

The foil adhesive 140 is formulated to adhere to the metal, e.g., aluminum 138 in the composite layer 132 as well as to the design layer 116. Examples of foil adhesives 140 are described in the aforementioned patent to Colella, U.S. Pat. No. 7,910,203. One example of a metal transferring adhesive layer 140 composition includes about 50.2%, by weight, UCAR VMCA solution vinyl resin (The Dow Chemical Company, Midland, Mich.); about 14.4%, by weight, Adhesion Resin LTH (Degussa Coatings and Colorants, Parsippany, N.J.); about 11.0%, by weight, SST-3 micronized Teflon (Shamrock Technologies, Inc., Newark, N.J.); about 12.8%, by weight, fumed silica (Cabot Corporation, Boston, Mass.); about 10.41%, by weight, S160 plasticizer (Eastman Chemical Company, Kingsport, Tenn.); and about 1.2%, by weight, Foamex N defoamer (Tego Chemie Service GmbH, Essen, Germany). This exemplary above composition contains about 37.5%, by weight, solids and about 62.5%, by weight, volatile materials. It will be appreciated that the composition of the metal transferring adhesive layer 140 may be based on any number of base resins that adhere to the selected metal 138, such as aluminum and to the design layer 116.

In an embodiment, the design layer 116 is an ink that is printed over the matting layer 114 (applied as an ink), the foil adhesive 140, as well as the metal 138 in the composite layer 132. The design layer 116 ink is formulated to have low affinity for the matting layer 114 and the aluminum layer 138 in composite 132. Optionally, an adhesive layer 120 is printed over the entire label 110 and is formulated to bond the design layer 116 to the target object T with the application of heat H and pressure P to the back side S of the carrier 112.

FIG. 5 shows the label 110 after transfer to the target object T. When the carrier 112 is peeled away, the matting layer 114 remains bonded to the composite layer 132 and does not transfer to the target object T. The foil adhesive 140 bonds to the metal 138 in the composite layer 132 as well as to the design layer 116 separating the foil composite layer 132 from the 112 carrier. The design layer 116 is also formulated to have a low affinity for the metal 138 (e.g., aluminum) surface of composite layer 132 so it will release cleanly from composite layer 132 during the transfer step.

FIG. 6 illustrates the exemplary transferred label 110 bonded to the target object T. As illustrated, the label 110 includes an area where the design layer 116 has a matte surface 144 matching the surface of the matting layer 114, a metallic area 146 where the foil adhesive 140 has transferred the foil composite layer 132, and a gloss surface 148 where the design layer 116 has transferred cleanly from the smooth surface of the metal 138 of the composite layer 132.

Again, this description is shown with only one design layer 116 for simplicity. In embodiments, the matte area 144, the metallic area 146, and the gloss area 148 can separate from one another with a different design color for the matte 144 and gloss 148 areas. Additionally, the foil composite 132 can be tinted to produce different colored metallic areas; e.g. a gold foil or a red foil, etc. Also, depending upon the target object T, it may not be necessary to have an adhesive layer 120 as the design layer 116 ink may bond directly to the target object T. Similarly, if there is an affinity between the foil adhesive 140 and the target object T it may not be necessary to print anything over the foil adhesive 140 as it will bond directly to the target object T by itself.

One can control the degree of mattness of the matting layer 114 through incorporation of matting agents which are known to those practiced in the art. By controlling the degree of mattness it would be possible to produce a label 10, 110 with varying gloss levels by using different matting inks in different areas of the label 10, 110.

The words “a” or “an” are to be taken to include both the singular and the plural. Conversely, any reference to plural items shall, where appropriate, include the singular. All patents and published application referred to in this disclosure are incorporated herein in their entirely whether or not expressly done so herein.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A variable gloss heat transfer label, comprising:
a carrier;
a matting layer on a portion of the carrier; and
a design layer having a first portion provided over the carrier and a second portion provided over the matting layer,
wherein the design layer is configured to separate from the matting layer and the carrier, and transfer and adhere the first and second portions of the design layer to a target object upon application of heat and pressure, and wherein the first portion of the design layer transferred to the target object from the carrier has a different gloss than the second portion of the design layer transferred to the target object from the matting layer.

2. The variable gloss heat transfer label of claim 1, wherein the first portion of the design layer transferred to the target object from the carrier has a higher gloss than the second portion of the design layer transferred to the target object from the matting layer.

3. The variable gloss heat transfer label of claim 1 including a release layer on the carrier, wherein the matting layer is on a portion of the release layer and wherein the first portion of the design layer is on the release layer and the second portion of the design layer is on the matting layer, and wherein the matting layer has a higher affinity for the release layer so that the matting layer remains on the release layer when the design layer is transferred to the target object.

4. The variable gloss heat transfer label of claim 1 including an adhesive layer on the design layer, the adhesive layer adhering the design layer to the target object.

5. The variable gloss heat transfer label of claim 1 wherein the matting layer is formed from a first cross-linkable composition provided on the carrier or the release layer.

6. The variable gloss heat transfer label of claim 1 wherein the design layer is formed from a second composition and configured to take up a matte finish from the matting layer.

7. The variable gloss heat transfer label of claim 6 wherein the second composition is a second cross-linkable composition.

8. The variable gloss heat transfer label of claim 7, wherein the matting layer is formed by printing a pass using a 2K silicone ink.

9. The variable gloss heat transfer label of claim 7, wherein the second cross-linkable composition is an ink formulation comprising a thermoplastic resin and a cross-linking agent.

10. The variable gloss heat transfer label of claim 7, wherein the second cross-linkable composition is an ink formulation comprising a thermoplastic resin, polyol and isocyanate, and wherein the thermoplastic resin is selected from thermoplastic polyurethanes, vinyl chloride/vinyl acetate copolymers, polymethacrylates, epoxides, and copolyesters.

11. The variable gloss heat transfer label of claim 4, wherein the adhesive layer is formed from an adhesive composition comprising a thermoplastic resin and hotmelt power.

12. The variable gloss heat transfer label of claim 4, wherein the adhesive layer is formed from a hotmelt powder resin, and wherein the hotmelt powder resin is selected from thermoplastic polyurethanes, copolyesters, and copolyamides.

13. The variable gloss heat transfer label of claim 1, wherein the matting layer is printed/applied so as to have a gloss differential of about 95+ relative to a portion of the design layer where there is no matting layer.

14. The variable gloss heat transfer label of claim 1 wherein the carrier has a composite foil layer, wherein at least a portion of the composite foil layer transfers with the design layer to the target object.

15. The variable gloss heat transfer label of claim 14 wherein another portion of the composite foil layer is overlain with the matting layer and does not transfer to the target object.

16. The variable gloss heat transfer label of claim 14 wherein the composite foil layer includes a metallizable layer and a metal layer, the variable gloss heat transfer label further including a metal layer transferring adhesive on the composite foil layer over the metal layer.

17. The variable gloss heat transfer label of claim 16 wherein the metal layer is an aluminum layer.

18. A method of making a variable gloss heat transfer label, comprising steps of:
printing a matting layer on a carrier; and
printing a design layer over at least a portion of the matting layer,
wherein when the variable gloss label is contacted to a target object and subject to heat and pressure, the design layer transfers to the target object such that a portion of the design layer overlying the matting layer has a matte finish and a portion of the design layer not overlying the matting layer has a gloss finish.

19. The method of claim 18, wherein the matting layer is printed on a carrier having a composite foil layer, and wherein at least a portion of the composite foil layer transfers with the portion of the design layer to the target object, and wherein another portion of the composite foil layer is overlain with the matting layer and does not transfer to the target object.

20. The method of claim 18, wherein the matting layer is printed/applied so as to have a gloss differential of about 95+ relative to a portion of the design layer where there is no matting layer.

21. A variable gloss heat transfer label, comprising:
a carrier having a matte finish;
a glossing layer on a portion of the carrier; and
a design layer having a first portion provided over the carrier and a second portion provided over the glossing layer,
wherein the design layer is configured to separate from the glossing layer and the carrier, and transfer and adhere the first and second portions of the design layer to a target object upon application of heat and pressure, and wherein the first portion of the design layer transferred to the target object from the carrier has a different gloss than the second portion of the design layer transferred to the target object from the glossing layer.

22. The variable gloss heat transfer label of claim 21, wherein the first portion of the design layer transferred to the target object from the carrier has a lower gloss than the second portion of the design layer transferred to the target object from the glossing layer.

23. The variable gloss heat transfer label of claim 21 including a release layer on the carrier, wherein the glossing layer is on a portion of the release layer and wherein the first portion of the design layer is on the release layer and the second portion of the design layer is on the glossing layer, and wherein the glossing layer has a higher affinity for the release layer so that the glossing layer remains on the release layer when the design layer is transferred to the target object.
